(19) United States
(12) Patent Application Publication
(10) Pub. No.: US 2010/0044432 A1
(43) Pub. Date: Feb. 25, 2010

(54) Vehicle Operating Chip with Gas Price Variation Capability

(76) Inventor: Ivonis MAZZAROLO, Vaudreuil (CA)

Correspondence Address: YOUNG BASILE, 3001 WEST BIG BEAVER ROAD, SUITE 624, TROY, MI, 48084, US

(21) Appl. No.: 12/195,612

(22) Filed: Aug. 21, 2008

(51) Int. Cl. G06K 5/00

(52) U.S. Cl. 235/380

(57) ABSTRACT

A fuel dispensing system which sets the price for fuel to be dispensed based on the mileage/fuel consumption history of a vehicle for which fuel is being purchased. A key is used both to enable vehicle operation and to transfer mileage data to the dispenser computer.

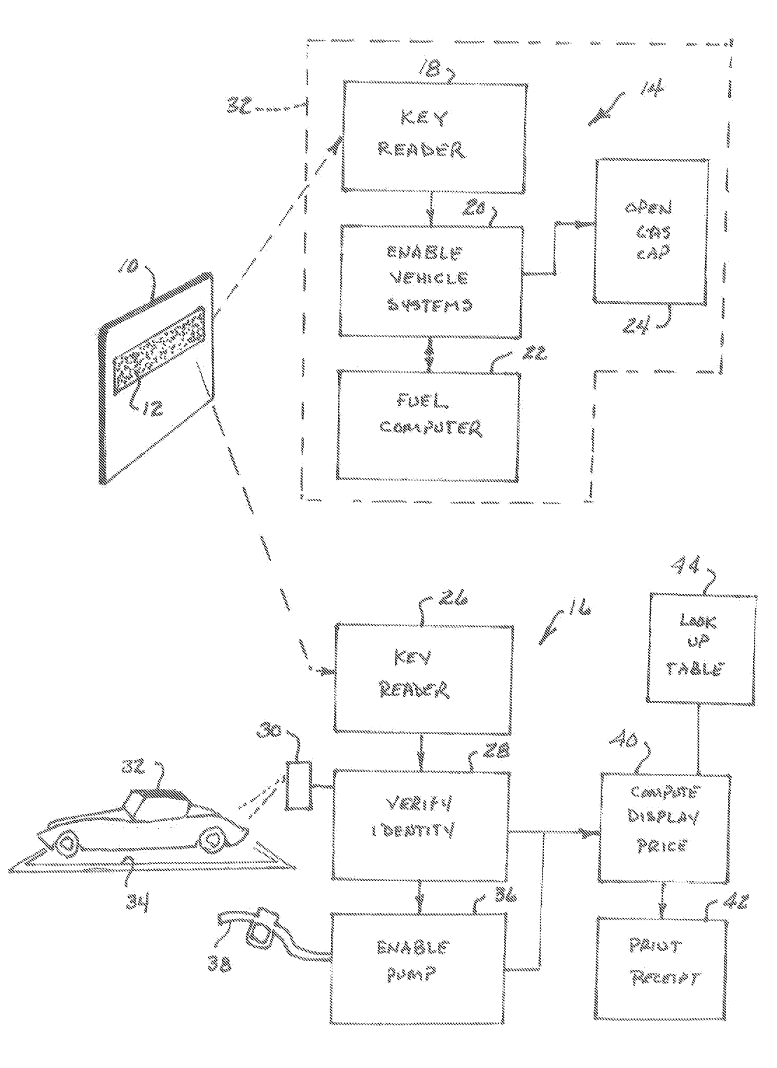

### FIELD OF THE INVENTION

This invention relates to fuel dispensing systems and more particularly to a fuel dispensing system which sets the price of fuel to be dispensed in accordance with the fuel consumption history of a vehicle for which fuel is to be dispensed.

### BACKGROUND OF THE INVENTION

Automotive fuel, such as gasoline or diesel fuel, is typically dispensed directly to a vehicle from a pump connected to an in-ground supply. This dispenser pump has a computation capability which, in the least sophisticated case, mechanically or electronically multiplies the quantity of fuel dispensed by a fixed price per unit of fuel volume. The price, of course, may be changed from time to time according to market conditions.

Various policies and means have been suggested and/or adopted for conserving fossil fuel. It is an established principle of economics that the higher price for a commodity, the more conservation-minded will the consumer become for that commodity.

### SUMMARY OF THE INVENTION

The present invention is, according to one aspect, a system for setting the price of fuel at a commercial dispensing station on the basis of the fuel consumption history of a particular fuel-consuming mechanism, typically but not necessarily an automotive vehicle, for which fuel is to be dispensed. In broad terms, the system comprises a fuel dispenser having a data port, a data bearing “key”, such as a credit card with a magnetic stripe memory, compatible with the dispenser data port and carrying updated data representing the fuel consumption history of a particular vehicle. A processor associated with the dispenser and responsive to the data from the key determines the price of fuel in accordance with a table which sets a higher price per unit of fuel for a vehicle with a poor fuel consumption history and a lower price pre unit for a vehicle with a better fuel consumption history. In this description, the term “fuel consumption history” refers to the efficiency of fuel utilization; e.g., distance traveled per unit of fuel consumed, typically expressed in “miles per gallon” of “kilometers per liter”. Algorithms may, however, be developed to take the frequency of refueling into account as well.

In another sense, the present invention is a method for setting and/or varying the price of fuel to be delivered by a commercial dispensing facility according to the fuel consumption history of each particular vehicle for which fuel is to be dispensed. In broad terms, the method comprises obtaining data regarding the identity and fuel consumption history of a particular mechanism such as a vehicle, inputting that data to the fuel dispenser computer and calculating the price, such as from a look-up table, per unit volume of fuel according to the fuel consumption history of the vehicle.

In both the apparatus and method aspects of the invention, fuel consumption history is carried by a “key” having two distinct functions: (1) to collect and store fuel consumption history data from the consuming mechanism, and (2) transfer the fuel consumption history data from the mechanism to the dispensing facility where the data is used to set the price for fuel to be dispensed. In the illustrated embodiment of the invention hereinafter described, the key performs the further function of (1) enabling operation of a vehicle, and (2) identifying the vehicle. As indicated above, the key may be in the form of a credit with a magnetic stripe but may take a variety of other forms capable of receiving, storing and updating fuel consumption and mileage information as well as, in the preferred form, a vehicle identity information which enables the commercial dispensing station to verify that fuel is being in fact dispensed to the vehicle for which fuel consumption history data has been obtained.

Other applications of the present invention will become apparent to those skilled in the art when the following description of the best mode contemplated for practicing the invention is read in conjunction with the accompanying drawing. For example, the invention may be used in connection with the operation of trucks, farm equipment, road-working equipment and airplanes, as well as fuel transporting equipment.

### BRIEF SUMMARY OF THE DRAWINGS

The single FIGURE illustrates the basic components of a system employing and/or embodying both the apparatus and method aspects of the invention.

### DETAILED DESCRIPTION OF THE ILLUSTRATIVE EMBODIMENT

As shown in the single FIGURE, a key 10 in the form of a durable credit card having a writable and readable magnetic stripe 12 is provided for two broadly defined purposes: first, to work in cooperation with a vehicle mounted system 14 and, second, to work in cooperation with a fuel dispenser located system 16.

The vehicle system 14 is placed entirely within a fuel-consuming automotive vehicle such as a passenger car, and comprises a conventional key reader 18 typically having a slot which accepts the key card 10 and reads data from the stripe 12 identifying the vehicle and, if an appropriate identification correlation is made, sending a signal to the vehicle electronics system 20 to enable vehicle systems such as the starter, panel lights, headlights, air conditioning system, airbag system, and other vehicle accessories. The key is, in this form, not twisted in the fashion of a conventional key to engage a starter. Rather, the insertion of the key 10 into the reader 18 simply arms the starter circuit and a pushbutton, for example, may be used to send current to the starter motor. Of course, a conventional twist key function may also be employed if the key 10 is designed for this additional purpose.

The appropriate entry and reading of the key 10 also accesses a conventional fuel computer 22 of the type carried by most modern vehicles. These fuel computers include flow meters and mileage calculators which maintain a running total of fuel consumption history in miles per gallon or kilometers per liter, depending on the units of the measurement system adopted by the particular country or state in which the vehicle is registered. The fuel consumption history data 22 is not only calculated and displayed within the vehicle but is also fed back to the key reader 18 and from there to the key 10 where it updates the information contained in the stripe 12 so that the stripe, at all times, contains a current cumulative fuel consumption history. This history is preferably cumulative over the life of the vehicle, but may also be calculated between fill-ups.

The vehicle enabled system 20 is also capable of either directly opening or enabling the opening function of the vehicle gas cap as indicated by the block 24. In this case, either a locking cap or a lockable door over the cap may be used.

Summarizing, the key 10 operates in connection with the onboard vehicle system 14 to enable vehicle functions in the manner of a conventional ignition key and also to obtain and store updated information regarding the fuel consumption history of the vehicle from the fuel computer 22. In both cases, the key must carry identification data which matches that of the vehicle itself.

Turning now to the system 16 associated with the commercial fuel dispensing station, a second key reader 26 is provided which is compatible with the key 10 and the stripe 12, or whatever other means is used to collect, store and convey vehicle identity information and vehicle fuel consumption history to the fuel dispensing system 16. The card reader or key reader 26 is connected to a processor 28 whose job it is to verify the identity of the vehicle. This is done in part by checking, for example, the vehicle identification number to make sure that it is valid and in part by activating an optical sensor 30 which is strategically stationed or located to obtain an image of the vehicle 32 placed within a well-defined area 34 in the dispensing station so that the image can verify the vehicle according to color, model, license number and any other data which is compatible with the optical scanner 30. In a more sophisticated system the scanner 30 and/or second scanner may be located in front of the vehicle to read the vehicle identification number through the windshield and convey that data to the processor 28 where it is compared to the vehicle identification information from the key card 10. This ensures that a consumer cannot bring a low mileage per gallon vehicle into a station and purchase fuel using a key card from a high mileage per gallon vehicle in order to enjoy a lower price.

The processor 28 enables the pump 36 so that fuel may be dispensed to the vehicle 32 through a conventional dispenser nozzle 38. Data is also communicated to a pump computer 40 which computes the price per unit of fuel to be charged for the particular vehicle 32 according to its fuel consumption history. In general, the better miles per gallon or kilometers per liter history achieved by the vehicle and recorded on the key card 10, the lower the price selected from the look-up table 44 will be. Conversely, a vehicle with poor mileage performance will result in the selection from a look-up table 44 of a higher price per unit of fuel. In this fashion, consumers using vehicles with high miles per gallon histories will pay less for fuel than consumers with lower mileage per unit vehicles. In any case, the price is preferably displayed at the pump prior to and during the actual dispensing function and finally, the total price is conveyed to a receipt printer 42 which prints and issues a receipt to the consumer. Key 10 may also function as a credit (or debit) card in the conventional function.

The computer 40 is preferably easily accessed by government officials and/or the station owner to vary the prices in the look-up table 44 from time to time as may be desired by the commercial operator and/or in accordance with prices set by a governing authority. Purely by way of example, a vehicle which has consumed 8 liters of fuel over 100 kilometers of registered distance traveled will result in a charge of $1.60 per liter for fuel dispensed. A vehicle that consumes 10 liters of fuel over the same 100 kilometer distance traveled will result in the selection from the look-up table 44 of a price of $1.80 per liter. In a given look-up table 44, for each liter less than 7 liters less than 100 kilometers used, a price break of $0.10 per liter will be revealed. Therefore, again by way of example, a vehicle consuming only 5 liters in 100 kilometers traveled will result in a selected price of only $1.30 per liter. These prices are illustrative only.

The key 10 serves two important functions; to operate the vehicle and to operate the fuel dispensing facility, while providing verifiable information to the fuel dispensing facility as to the authentic identity of the vehicle and its cumulative fuel consumption or mileage history. The verification function, including the optical scanner 30 is to prevent fraud and would be unnecessary in an ideal society or a system with other equally effective means of verification. Means may be provided for updating data to a fresh key 10 in the event an original key is lost along with the cumulative data from the fuel computer 22. While the system preferably uses cumulative fuel consumption data beginning with the original commissioning of the vehicle, there is considerable value in a system which computes fuel consumption history only from the last fill-up and the present invention contemplates either or both approaches. In addition, the system algorithm may take frequency of fuel delivery into account. The system does not deny consumers access to fuel, it simply varies the price according to how efficiently it is used, and in that sense encourages more efficient usage.

What is claimed is:

1. A system for setting the price of dispensed fuel on the basis of the fuel consumption history of the vehicle for which said fuel is dispensed comprising:
a fuel dispenser associated with a fuel supply and having a data port;
a data bearing key compatible with said port and bearing data representing the fuel consumption history of an automotive vehicle; and
a processor associated with said dispenser and responsive to the entry of said data from said key to said port to determine the price to be charged for fuel delivered by said dispenser.

2. A system as defined in claim 1 wherein said key bears data representing the identity of a vehicle.

3. A system as defined in claim 2 further including means associated with said dispenser for collecting identification data from a nearby vehicle and comparing said data to the identity data from said key.

4. A system as defined in claim 3 wherein said means includes an optical scanner.

5. A system as defined in claim 1 further including a vehicle equipped with a fuel consumption history computer with a data port compatible with said key and means responsive to data carried by said key and entered by way of said port for retrieving fuel consumption history from said fuel computer.

6. A method for setting the price of dispensed fuel according to the fuel consumption history of a vehicle for which fuel is dispensed comprising the steps of:
obtaining fuel consumption history from a vehicle;
inputting the fuel consumption data history from said vehicle to a fuel dispenser; and
computing a price for fuel to be dispensed to the vehicle from a table of prices related to fuel consumption history data.

7. A method as defined in claim 6 including the further steps of:
displaying a computed price for fuel for the vehicle for which data has been entered; and
enabling a fuel dispenser to dispense fuel to the vehicle.

8. The method defined in claim 7 further including the step of verifying the identity of the vehicle prior to enabling the dispenser.
